(19) United States
(12) Patent Application Publication
(10) Pub. No.: US 2025/0034847 A1
(43) Pub. Date: Jan. 30, 2025

(54) WATER GENERATOR FOR GENERATING WATER FROM ATMOSPHERIC AMBIENT AIR

(71) Applicant: Imhotep.Industries GmbH, Freistadt (AT)

(72) Inventors: Manfred LEDERMÜLLER, Vorderweissenbach (AT); Urs HUNZIKER, Meilen (CH)

(73) Assignee: Imhotep.Industries GmbH, Freistadt (AT)

(21) Appl. No.: 18/715,885

(22) PCT Filed: Dec. 1, 2022
(86) PCT No.: PCT/EP2022/084010

§ 371 Date: Jun. 3, 2024

(30) Foreign Application Priority Data
Dec. 3, 2021 (DE) 10 2021 131 985.4

(51) Int. Cl. E03B 3/28; B01D 53/26

(52) U.S. Cl. CPC E03B 3/28; B01D 53/265

(57) ABSTRACT

The present disclosure relates to a water generator for generating water from atmospheric ambient air, wherein the water generator in particular comprises an energy efficiency of less than 250 W/liter water yield. A suction region, a technical region and a blowout region of the water generator are arranged such that at least a part of the humidity-reduced product air is flowable from the suction region through the technical region under thermally coupling with at least a part of technical components in the blowout region. Under evaporation of a refrigerant, and the cooling power generated therefrom, water and humidity-reduced product air are generated from the ambient air in a water collection unit in the suction region.

### TECHNICAL FIELD

The present invention relates to an atmospheric water generator and a method for generating water from ambient air.

### BACKGROUND OF THE INVENTION

Atmospheric water generators generate water from atmospheric air. By cooling the ambient air below the dew point, water condenses from the ambient air and may be used for the further processing, e.g. for a drinking water supply. The developments of atmospheric water generators are in particular directed to an increase of efficiency. It is extremely difficult to obtain noticeable increases in efficiency, so that improved concepts achieve only slightly better degrees of efficiency neither in the water yield per energy amount, nor per time or per device volume. This also means that atmospheric water generators which comprise an instable operation comprise a significantly worse degree of efficiency.

Atmospheric water generators are frequently used in arid regions. In arid regions, often dry and hot atmospheric conditions prevail. In particular, adverse environmental conditions are present, e.g. a high dust load, a disturbing dust composition, e.g. a suction air which is contaminated with ferromagnetic particles, or operation conditions, e.g. short power failures or a high outside temperature. These factors effect the total efficiency of the system in a reducing manner in a long-term view, for example since after a power failure, it takes a certain time until the system is regulated at the optimum point of efficiency again, or since each regulation adaption of the efficiency control is based on a disturbance which causes a reduced efficiency in the time between a deviation from a target value to reaching the target condition again. Furthermore, the total efficiency is reduced, since during cleaning breaks for polluted technique, the water generator has to be switched off and therefore does not produce water. In addition, at higher temperatures, the degree of efficiency of system components is reduced due to aging effects, and their service life is reduced, which in turn may lead to a service shutdown of the system.

### DESCRIPTION OF THE INVENTION

It is an object of the present invention to provide a robust atmospheric water generator which comprises a high degree of efficiency and which can be quickly adjusted to a predetermined operation condition.

This object is solved by an atmospheric water generator and a method for operating an atmospheric water generator according to the subject-matters of the independent claims.

According to a first aspect of the present invention, a water generator for generating water from atmospheric ambient air is provided, wherein the water generator, in particular at a preferred exemplary operation point, comprises an energy efficiency of less than 250 W/liter water yield. The water generator comprises a refrigerant cycle for generating cooling power. The water generator further comprises a suction region in which ambient air from an ambience is suckable, wherein the suction region comprises a water collection unit (German: Wassergewinnungseinheit) with a cooling register. The cooling register is coupled with the refrigerant cycle and adapted such that, by the cooling power of the refrigerant cycle, from the ambient air which is flowable as product air at least partially through the cooling register, water and humidity-reduced product air is generatable.

Furthermore, the water generator comprises a technical region in which technical components comprising at least one control unit for operating the water generator are installed, wherein the metal portion of the technical components in the technical region comprises more than 500 kg.

Furthermore, the water generator comprises a blowout region for blowing out the humidity-reduced product air into the ambience.

Furthermore, the water generator comprises a compressor for compressing the refrigerant, wherein the compressor comprises a maximum connection power (German: Anschlussleistung) in a range from 70 kW to 200 kW. The blowout region comprises a re-cooling unit (German: Rückkühleinrichtung) which is thermally coupled with the refrigerant cycle and is adapted for liquefying the refrigerant under release of waste heat, wherein ambient air from the ambience can flow into the blowout region.

The suction region, the technical region and the blowout region are arranged such that at least a part of the humidity-reduced product air is flowable from the suction region through the technical region into the blowout region under thermally coupling with at least a part of the technical components, wherein in the blowout region, the part of the humidity-reduced product air is mixable with the sucked ambient air (in particular the ambient air which is flowing into the blowout region), and is subsequently flowable through the re-cooling unit for a removal of the waste heat.

The control unit is configured to control the product air such that the relative air humidity in the (humidity-reduced) product air in the technical region is less than 60%, and such that the temperature of the (humidity-reduced) product air in the technical region is adjustable to be cooler than the ambient air.

Furthermore, a method for operating an above-described atmospheric water generator for generating water from atmospheric ambient air is described, wherein the water generator, in particular at a preferred operation point, comprises an energy efficiency of less than 250 W/liter water yield.

The water generator according to the invention comprises substantially three main regions, i.e. the suction region, the technical region and the blowout region. In the flow direction of the product air through the water generator, the suction region, the technical region and the blowout region are subsequently arranged. The main regions may form a common housing. Furthermore, the main regions may respectively comprise an own carrying structure and/or separate housings which may be coupled with each other in a modular manner.

In the suction region, for example a ventilator for sucking ambient air is located. The ambient air is sucked into the suction region as product air and is in particular flowed into the water collection unit in which the product air is cooled down, in particular below the dew point. The cooling power is in particular generated by a refrigerant from a refrigerant cycle.

The refrigerant cycle in particular comprises an evaporating unit in which the refrigerant evaporates and is therefore cooled. The evaporating unit is directly coupled with the cooling register of the water collection unit in the suction region or is coupled via a first cooling coupling cycle (German: Kältekopplungskreislauf) with the cooling register. The evaporated refrigerant is forwarded to the compressor which increases the pressure of the refrigerant and forwards to the liquefying unit. In the liquefying unit, the refrigerant is directly or indirectly cooled by ambient air and the humidity-reduced product air, until a liquid state of the refrigerant is achieved. The liquefying unit is directly coupled with the re-cooling unit in the blowout region or is coupled via a second cooling coupling cycle with the re-cooling unit. Subsequently, the refrigerant is forwarded to an expansion valve for reducing the pressure and is finally forwarded to the evaporator again.

The refrigerant serves for transporting enthalpy (heat energy) directly from the water collection unit or indirectly via the first cooling coupling cycle to the ambience. The refrigerant cycle is in particular operated by supplying energy, i.e. by a compression by the compressor. For example, the refrigerant may be based on halogenated hydrocarbons, such as R134a or R513a.

The water collection unit comprises the cooling register. The cooling register forms a heat transfer unit between the ambient air which is flowing in from outside, which flows through the cooling register as warmer product air, and the cooling power of the refrigerant cycle. Thereby, the dew point is undercut and in the cooling register and/or a drop separator (German: Tropfenabscheider) of the water collection unit, the humidity content of the product air is reduced for the water generation.

By the atmospheric water generator according to the invention, in particular warm ambient air is sucked in the suction region and is, directly or via a cooling coupling cycle, cooled as product air by a refrigerant cycle which is operated by the refrigerant, until the dew point is undercut, and the air humidity of the product air condenses. The cooling energy which is necessary for this is supplied by a refrigerating machine (German: Kältemaschine). The heat which is removed from the air is removed to the ambience again via the re-cooling unit and e.g. via the liquefying unit for liquefying the refrigerant.

In the following, ambient air describes an air which is flowing into the water generator from an ambience which surrounds the water generator (for example the entire housing of the water generator). The product air describes the ambient air which flows into the water generator and flows in the interior (for example in the interior of the entire housing of the water generator). After the water collection unit, the product air is a humidity-reduced product air, since after flowing through the water collection unit, water is condensed, and the humidity content of the product air is reduced. In the water collection unit, for example more than 50%, 80% or more than 90% of the water content of the product air may be condensed. According to the invention, the humidity-reduced product air flows after the water collection unit through the technical region into the blowout region. In particular, a part of the product air may be supplied to the water collection unit, or the entire volume flow of the product air may be supplied to the water collection unit. After the water collection unit, a part of the humidity-reduced product air or the entire volume flow of the humidity-reduced product air may be guided through the technical region into the blowout region.

In the technical region, more than 80%, more than 90%, in particular all technical components of the water generator are arranged which do not serve for the airflow guidance (such as tube conduits or air channels) or are fans. In the following, the term technical component denotes a technical component which contributes actively, i.e. mechanically, electrically or magnetically, to the control of the power of the water generator or to the operation of the water generator, or mechanical housings and carrier constructions of such. A technical component is in particular a current-operated component and/or comprises mechanically movable control elements, such as rotatably or translationally movable mechanical elements. For example, a controllable valve may constitute a technical component. In particular, the control unit is a technical component. Furthermore, a tube conduit for a fluid, for example the product air or the refrigerant, may constitute the technical component. In particular, in the context of the present application, technical components encompass components which are partially or completely made of a metallic material.

The technical components are flown around by the humidity-reduced product air and are therefore thermally coupled. Thermally coupled means that heat from the technical components is transferred to the cooled humidity-reduced product air. According to the present invention, the entirety of the technical components in the technical region comprises a metal portion of more than 500 kg. This means that a high metal portion in the technical region is present which is cooled by the humidity-reduced product air. Due to the high metal portion, the technical components store the coldness. This means on the one hand that an operation at a high temperature of the technical components is reduced and for example no separate cooling aggregates must be installed in the technical region. At the same time, storing the coldness also means that after a disturbance-caused interruption of the operation of the water generator, during the restart of the operation, an optimum operation state can be adjusted more quickly. This is caused by the fact that when starting the water generator, at first the refrigerant cycle comprises a poor efficiency and the humidity-reduced product air is only slightly cooled in the water collection unit. After flowing through the technical region, the humidity-reduced product air is further cooled due to the stored coldness, such that this cooler product air in the outflow region, where the re-cooling unit is present, can cool the refrigerant in a better way, and therefore the refrigerant may be cooled in a more efficient manner, such that the optimum operation state after restarting the operation of the water generator can be adjusted more rapidly.

In the blowout region, the re-cooling unit (and in an exemplary embodiment also the liquefying unit of the refrigerant cycle) is installed. The re-cooling unit is cooled by the flown-in ambient air and by the humidity-reduced product air which flows out of the technical region into the blowout region. By the additional cooling and/or the reduced heating of the humidity-reduced product air, the efficiency of the re-cooling unit and correspondingly of the liquefying unit which is directly or indirectly coupled, and therefore of the entire refrigerant cycle is increased. After flowing around the re-cooling unit, the waste air, consisting of the humidity-reduced product air and the ambient air which flows into the blowout region, is blown out by a fan.

Furthermore, at the arrangement of the water generator according to the invention, the blowout region is spatially separated from the suction region by the technical region. Therefore, the location where the ambient air is sucked for the water collection unit into the suction region is spatially distanced from the location where in the blowout region the waste air which is heated by the re-cooling unit is blown out. Therefore, mixing the warm waste air with the cooler ambient air which is supplied in the suction region is prevented and an efficiency reduction is avoided. In conventional approaches, at a spatial proximity of the air suction in the suction region and the blowout opening of the re-cooler and/or liquefier in the blowout region, short-circuits in the air guidance occur, i.e. the warm drain air of the re-cooler mixes with the ambient air in the proximity of the suction opening in the suction region and heats the sucked ambient air. Therefore, much energy has to be invested to reach the starting temperature again. In the water generator according to the invention, the inlet is located in the suction region not directly at the inlet in the suction region, but diametrically opposite at the other end of the water generator.

For example, the power of the water generator is controlled by the control of the compressor for compressing the refrigerant. For example, when the compressing power of the compressor is adapted to the optimal operation point of the compressor, the refrigerant may cool the product air in a more efficient manner and correspondingly, the amount of generated water can be controlled. Furthermore, the power of the water generator can be controlled by the volume flow of the ambient air which is flown in in the suction region and/or by the volume flow of the ambient air which is flown in in the blowout region. By the adjusted volume flow of the product air in the suction region into the water collecting unit, the amount of humidity-reduced product air may be adjusted. For example, the corresponding volume flows may be controlled by corresponding ventilators in the suction region and/or in the blowout region. According to the invention, for the compressor of the water generator, a maximum connection power of more than 70 kW is selected, since with a smaller connection power, the time for an initial cooling of the technical region as coldness storage is too high. At more than 200 kW maximum connection power, the flow amounts of the product air which are required for the operation will get so high that a required reliable gas leakage detection of the refrigerant is merely possible, for example.

In particular, the control unit is provided for operating the water generator and is installed in the technical region. The control unit controls in particular the compressor. Furthermore, the control unit may control the corresponding ventilators for adjusting the volume flows of the product air and/or the inflowing ambient air in the blowout region. The control unit may also be used for monitoring the water filters and processing, controlling pumps and valves in possible intermediate cycles and/or controlling security functions. Therefore, according to the invention, the humidity-reduced product air in the technical region may comprise a relative humidity of less than 60%. According to a further exemplary embodiment, the control unit is configured for controlling the product air such that the humidity-reduced product air in the technical region comprises a relative air humidity of less than 50%, in particular less than 40%.

Furthermore, in the water generator, corresponding sensors may be arranged, to measure suitable operation parameters. For example, in the suction region, the technical region and/or the blowout region, corresponding temperature sensors, air pressure sensors and/or air humidity sensors may be provided. Furthermore, corresponding outer sensors outside the water generator may be provided to measure the temperature, the air pressure and the relative humidity of the ambient air, for example. In particular, the control unit may be coupled with the sensors which are located inside and/or the outer sensors, to control the compressor and/or the ventilators based on the corresponding sensor data, and therefore to adjust an optimum operation point for the generation of water in the water collection unit. In particular, the control unit comprises a processor and is configured to transmit control commands via a data coupling to the components (e.g. compressor, ventilators). Furthermore, the control unit is configured to receive control commands via an internal or external input unit. Furthermore, the control unit is configured to automatically generate control commands by a control logic and e.g. a coupled database. Furthermore, the control unit is coupled to the internal or external sensors, to generate control commands based on measured parameters (e.g. temperature, air pressure, air humidity).

For example, the control unit controls the air throughput via the ventilators and fans, but also the cooling power via the compressor. By controlling the air throughput or the amount of coldness in the technical region, also the residual humidity content, in particular the relative air humidity in the humidity-reduced product air, can be controlled. A suitable control can both delimit the maximum relative air humidity in the humidity-reduced product air to 60% and control the change of the dew point which would lead to a condensate formation in the interior of the electronic cabinet. In particular, by suitable control mechanisms, this residual humidity value may be controlled even lower. Therefore, by suitable configurations, values below 50% relative air humidity, in particular below 40% relative air humidity, could be achieved.

The advantages of the water generator according to invention can be summarized as follows. In conventional approaches, the product air which is humidity-reduced in the suction region, is blown back to the outside as waste air or is directly supplied to the re-cooler of the refrigerant. In the solution according to the invention, the humid product air in the suction region is at first filtered and is at the most dehumidified for the first time, is then conducted, e.g. via a cross heat exchanger of the water collection unit, is optionally dehumidified another time, and is then blown out, however through the entire technical region. The humidity-reduced product air is then mixed with the re-cooling air (ambient air) in the blowout region and is blown through the re-cooler (and in an exemplary embodiment also the liquefying unit) to the outside again.

This special construction approach has the following advantages. At first, no additional waste air guidance in the suction region is required, since the normal outer sleeve of the technical region serves as air guidance. This leads to a reduction in size, material and weight of the water generator.

By the high volume flow of humidity-reduced product air which is flowing through, the technical components in the technical region are rapidly cooled. This is efficient for the start, in particular the restart (e.g. after a short interruption of the voltage supply) of the water generator, since in this way, the optimum operation points of the water generator are reached again. Thus, large amounts of technical components, i.e. of technical material and construction elements, are rapidly cooled. A prominent part of the technical components has both a large heat capacity and a proper heat conductivity, since the technical components typically predominantly comprise metals. Thereby, the technical region can be used as a coldness storage which, in the case of short interruptions of the voltage supply, optimizes the subsequent restart, such that, by the improved temperature maintenance in the technical region, the regulated flaps, valves and other control elements can still remain in the optimum (i.e. most efficient) operation position.

Furthermore, by supplying the humidity-reduced product air into the re-cooling unit in the blowout region, the latter may profit from the lower temperatures (with respect to the ambient air) of the humidity-reduced product air and may therefore operate more efficiently. By supplying the already purified and humidity-reduced product air into the re-cooling unit, its external supply air volume flow of the ambient air is reduced in amount, which leads to a reduced occupation of e.g. input fins (German: Eingangslamellen) with contaminants (i.e. less operation interruptions for cleaning). Additionally, the energy amount for the operation of the re-cooling of the refrigerant is reduced, since the humidity-reduced product air is cooler than the external sucked ambient air.

Due to guiding the humidity-reduced product air through the technical region, the material for a separate ventilation in the technical region can be saved. The product air is dehumidified after the water removal and therefore, a distinct advantage with respect to the corrosion of materials in the technical region is offered. In particular in case of an installation near the sea, where humid salty air is to be expected, this leads to a substantial advantage.

Substantially, the substantial technical components are completely integrated inside the technical region (i.e. within the housing of the water generator) and are therefore flown around, such that all technical components are cooled completely and homogenously. If an outer plant portion would only be cooled on one side and is in contact with the outer air on the other side (e.g. switching cabinet (German: Schaltschrank)), condensation and corrosion may occur at the side of the outer air.

In particular, the suction region and the technical region may be formed such that the flow cross-section of the product air in the suction region is adapted to or is the same as the flow cross-section of the humidity-reduced product air in the technical region, for enabling that the entire product air from the suction region can flow through the technical region, and no excessive pressure drop occurs which in turn would reduce the efficiency. According to a further exemplary embodiment, the refrigerant cycle comprises an evaporating unit for evaporating the refrigerant. As described above, in the evaporating unit, the refrigerant is evaporated, such that a cooling power is generated by which the product air is cooled which flows around the cooling register.

According to a further exemplary embodiment, the evaporating unit in particular is arranged in the suction unit and is thermally coupled with the cooling register, to transfer the cooling power of the refrigerant onto the cooling register. The evaporating unit is integrated in the water collection unit, for example, such that also the refrigerant is guided into the suction region to the evaporating unit.

According to a further exemplary embodiment, the water generator further comprises a first cooling coupling cycle which is thermally coupled with the evaporating unit and the cooling register, such that a (first) thermal carrier medium of the first cooling coupling cycle transfers the cooling power of the refrigerant to the cooling register, wherein the evaporating unit is arranged separately from the cooling register, in particular in the technical region. For example, the cooling coupling cycle is operated with a liquid, for example with water, as thermal carrier medium. The cooling coupling cycle comprises a heat exchanger at the evaporating unit, for example, to transfer the cooling power from the refrigerant on the thermal carrier medium. Furthermore, a further heat exchanger is provided at the water collection unit, for the thermal carrier medium transferring the cooling power for example to the cooling register, for cooling the product air below the dew point in this way. Thus, for example the entire refrigerant cycle and its technical components may be arranged in the technical region.

According to a further exemplary embodiment, the refrigerant cycle comprises a liquefying unit for liquefying the refrigerant.

According to a further exemplary embodiment, the liquefying unit in particular is arranged in the blowout region and is thermally coupled with the re-cooling unit for cooling the refrigerant. For example, the liquefying unit is integrated in the re-cooling unit, such that also the refrigerant is guided into the blowout region to the liquefying unit.

According to a further exemplary embodiment, the water generator further comprises a second cooling coupling cycle which is thermally coupled with the liquefying unit and the re-cooling unit, such that a second thermal carrier medium of the second cooling coupling cycle transfers a cooling power of the second thermal carrier medium to the liquefying unit for cooling the refrigerant. The liquefying unit is arranged separately from the re-cooling unit, in particular in the technical region. For example, the second cooling coupling cycle is operated by a liquid, for example by water, as thermal carrier medium. For example, the cooling coupling cycle comprises a heat exchanger at the liquefying unit, to transfer the heat from the refrigerant to the thermal carrier medium. Furthermore, a further heat exchanger is provided at the re-cooling unit, for the thermal carrier medium transferring the heat for example to the re-cooling unit in this way, which in turn is cooled by the inflowing ambient air and the humidity-reduced product air. Therefore, for example, the entire refrigerant cycle and its technical components can be arranged in the technical region.

According to a further exemplary embodiment, the energy efficiency under predetermined conditions is below 250 W/liter water yield, preferably below 200 W/liter water yield. This high efficiency is in particular achieved by the structural arrangement of the suction region, the technical region and the blowout region according to the invention, and the separation of the sucked ambient air with the blown-out waste air which is generated thereby. Furthermore, this high efficiency is in particular achieved by the humidity-reduced product air flowing through the technical region and, when being flown in the blowout region, mixes with the ambient air, to therefore achieve a larger cooling capacity for the re-cooling unit and/or the coupled liquefying unit.

According to a further exemplary embodiment, the length of the technical region is more than 1 m, in particular more than 2 m, further in particular more than 3 m. Therefore, the outlet of the humidity-reduced air in the suction region is distanced from the suction in the suction region additionally by the length of the technical region, whereby the risk of sucking heated, blown-out waste air is reduced.

According to a further exemplary embodiment, the volume flow of the product air is constant. The constant volume flow is in particular adjusted by controlling the ventilators by the control unit. According to the invention, the volume flow through the technical region may be adjustable between 10,000 m³/h and 30,000 m³/h. In particular, this is also achieved in a system conceptional manner by the special arrangement and the flow cross-sections of the suction region, the technical region and the blowout region.

Due to this constant volume flow, the risk of the condensate formation or thermal aging of the technical components is reduced (e.g. by operating the corresponding fan with a fix power and/or a fix rotational speed). In this way, it is achieved that the volume flow of the product air in the steady state (German: eingeschwungener Zustand) is almost constant. By the adjusted volume flows according to the invention, changes in the flow-through velocity, for example in the technical region, lead to the displacement of small swirls which are generated around disturbances (e.g. conduits). Especially these local displacements of flows can change the heat reception of a subsequent technical component such that, at a certain flown-through location in the technical region, heat can be received very well and, in turn, at another location, the heat is received very poorly. This leads to an unexpectedly strong temperature variance in the mentioned technical components, which in turn may lead either to a condensate formation or to an increased aging (varying temperatures). According to the invention, the efficiency and the operation point may be controlled via the electric power which is supplied to the compressor and the re-cooler (liquefying unit), and by the heat carrier medium dynamics and the air guidance in the interior of the system.

The large volume flow according to the invention which is adjusted in this way also prevents dust deposits, in particular agglomerations of dust particles in the technical region.

By the high volume flow through the suction region and the technical region, and the flow-technical resistances which are resulting therefrom, in these both regions, an overpressure results which is possibly above the ambience pressure. This prevents or impedes also the introduction of foreign bodies, such as dust or rain.

According to a further exemplary embodiment, the humidity-reduced product air in the technical region is adjustable such that the humidity-reduced product air is cooler than the ambient air by more than 2° C., in particular by more than 4° C., in particular by more than 5° C., in particular by more than 7° C. According to a further exemplary embodiment, the humidity-reduced product air in the technical region is adjustable such that the humidity-reduced product air is less than 10° C., in particular less than 8° C., in particular less than 7° C., cooler than the ambient air. In particular, the humidity-reduced product air may be adjusted to be less than 5° C., less than 3° C., or even 1° C., cooler than the ambient air.

In an exemplary embodiment, by the water generator according to the invention, it is adjusted for example between 2° C. and 10° C., in particular between 4° C. and 8° C., further in particular between 5° C. and 7° C., cooler than the ambient air.

According to a further exemplary embodiment, the control unit is configured for controlling the humidity-reduced product air such that an increase in temperature of the humidity-reduced product air while flowing through the technical region is less than 3° C., in particular less than 2° C., further in particular less than 1° C.

The temperature of the humidity-reduced product air is adjustable by the control unit, in particular via the airflow of the ambient air in the suction region and by the compressor power of the refrigerant cycle.

The water collection unit in the suction region comprises a first heat exchanger which is supplied with the thermal carrier medium of the first cooling coupling cycle and on the other hand by the warm sucked-in product air, for example, such that the product air is cooled. In a condenser or drop separator of the water collection unit, the relative air humidity of the humidity-reduced product air is reduced to below 40%, for example. The humidity-reduced product air which is cooled so strongly is subsequently supplied in a second heat exchanger. The sucked-in product air, after entering the suction region, also flows directly in the second heat exchanger. Therefore, the humidity-reduced product air from the water collection unit pre-cools the sucked-in product air and is itself heated again. The therefore already pre-cooled sucked-in product air is supplied via a second drop separator to the first heat exchanger. The heated humidity-reduced product air, when flowing in the technical region, then comprises a lower temperature compared to the ambient air and may be used for a moderate cooling of the technical components in the technical region, without a risk of condensing at the technical components being existing.

In the following table, respectively the temperature of the product air and the relative air humidity with respect to the dew point (temperature dependent) is specified. Therefore, by the inventive water generator, the following values can be obtained. In the first column, the temperature and the relative humidity content are specified. In the second column, the state of the product air after the first heat exchanger is specified. The temperature which is adjusted there is the temperature at the dew point. At the dew point, the relative air humidity is 100% and the air is (just) saturated with water vapor. In the third column, the temperature of the product air after the second heat exchanger is illustrated. Between the second heat exchanger and the first heat exchanger, respectively drop separators are located which collect the condensed water. The fourth column shows the temperature and the relative air humidity of the humidity-reduced product air before entering the technical region. As shown in the examples for different temperatures and air humidities of the outer air which are illustrated in the rows, the humidity-reduced product air, prior to flowing in the technical region, is moderately cooled and strongly dehumidified compared to the ambient air.

| | Air state after | | Air state after |
|---|---|---|---|
| | pre-cooling in | | cross flow heat |
| | cross flow heat | Air state after the | exchanger |
| Outer air state | exchanger | cooling register | (rinsing air) |
| 25° C. @ 75% | 16.5° C. @ 100% | 6.4° C. @ 100% | 22.4° C. @ 35% |
| 30° C. @ 70% | 20.0° C. @ 100% | 7.5° C. @ 100% | 27.2° C. @ 29% |
| 35° C. @ 55% | 21.8° C. @ 100% | 9.8° C. @ 100% | 30.0° C. @ 29% |
| 40° C. @ 45% | 24.7° C. @ 100% | 16.1° C. @ 100% | 34.0° C. @ 34% |

This shows that by the solution according to the invention, the temperature of the humidity-reduced product air can be kept below the ambient temperature, which, when using it in the technical region, in particular in view of the high volume flow, enables a cooling of the technical components instead of a pure conventional ventilation (German: Lüftung). According to the invention, it is not cooled-down too far, since in case of an interruption of the operation of the water generator, a condensate can be generated in the technical region. According to the invention, a temperature decrease of 2° C. to 7° C. below the outer temperature level may be adjusted. In particular, it has shown that in case of a temperature decrease below 10° C., 8° C., or e.g. below 7° C., the efficiency of the water collection deteriorates. However, by the corresponding implementations of the water generator according to the invention, it is nevertheless possible to avoid a decreased energy efficiency in the steady state. In this way, with the implementation of the water generator according to the invention, it is possible to maintain the airflow in the technical region of more than 2° C., in particular more than 4° C. or 5° C., below the ambient temperature.

For the purpose that as less heat as possible has to be removed in the technical region, of course the selection of the components is relevant. For example, when using magnetic bearings of the compressor of the refrigerant cycle, a cooler operation due to a lower friction can be enabled. When using magnetic bearings for compressor shafts, the shaft of the rotor hovers in a magnetic field, such that friction and corresponding heat is merely generated.

According to a further exemplary embodiment, an air exchange in the technical region with respect to the inner volume of the technical region is more than 200 times, in particular more than 500 times, in particular more than 1000 times, of the inner volume of the technical region per hour. Therefore, according to the invention, a high cooling power can be enabled when the air exchange in the technical region with respect to its inner volume is sufficiently high. In particular, good results are achieved when the air exchange is more than 200 times, preferably more than 500 times, in particular more than 1000 times, of the inner volume of the technical region. The high air velocity which is adjusting by this high air exchange rate serves for a homogenous temperature, in particular of the technical components, being adjusted, which in particular thereby also reduces mechanical tensions among the technical components. At lower air exchange rates, by the waste heat of the technical components of the technical region, a larger temperature gradient between the air inlet and the air outlet in the technical region may be generated. With the high air exchange rates according to the invention, temperature increases of the humidity-reduced product air which is flowing through the technical region of less than 3° C., in particular less than 2° C., preferably less than 1° C., have been achieved.

According to a further exemplary embodiment, the metal portion in the technical region is more than 1000 kg, in particular more than 2000 kg, further in particular more than 3000 kg. Construction metal parts in general have a good heat conductivity of more than 20 W/m*K and comprise a heat capacity of more than 200 J/kg*K. Thus, besides their function as construction metal, they are also suitable for the coldness storage and are utilized for this purpose by the coldness storage system according to the invention.

According to a further exemplary embodiment, the water generator comprises a filter unit for filtering the product air, wherein the filter unit is configured such that more than 60% of all particles with a size of 0.3 μm to 1 μm are filterable out of the product air which is flowing through the technical region. In particular, the filter unit is arranged at the inlet region of the suction region, such that the filter unit filters the ambient air which is flowing into the suction region. A further filter unit may be provided at the air inlet of the ambient air in the outlet region, for example.

By filtering the airflow of the ambient air, a less frequent cleaning is enabled, which increases the operation time and therefore the annual efficiency. The metals which are used for the technical components in the technical region frequently also have a high portion of ferromagnetic particles (e.g. simple screws, steel, etc.). While the normal dust is properly transported by the high flow velocity in the technical region via the blowout region to the outside again, ferri- or ferromagnetic particles in the supply air may deposit at ferromagnetic construction material in the technical region, may be accumulated there, and then larger structures may be carried away again by the humidity-reduced product air and may cause either electrical, mechanical, or magnetical problems.

In the solution according to the invention, this is addressed by especially properly filtering the product air. Therefore, in particular filter units with the specification ISO Rating 16890 ePM1 60% 54.6 m² have turned out to be suitable. That is, by the filtering unit, a depletion of the ambient air is achieved, wherein more than 60% of all particles with a size from 0.3 μm to 1 μm are separated.

According to a further exemplary embodiment, the water generator comprises a gas leakage sensor for determining a portion of the refrigerant in the product air, wherein the gas leakage sensor is arranged in the technical region. The gas leakage sensor comprises for the determination of the refrigerant a sensitivity of more than 20 ppm (parts per million) of the refrigerant in the product air.

By the gas leakage sensor according to the invention, a detection of gas leaks in the refrigerant cycle is possible, despite only minimum gas amounts of a small leak mix with the large amounts of the product air.

For the gas leakage monitoring of the refrigerant, the gas leakage sensor is used which is sensitive according to the invention. It balances the extreme dilution of exiting gases of the refrigerant which occurs due to the high volume flow. Additionally, the gas leakage sensor is mounted such that it is arranged downstream to possible leaks in the flow. Referring to a probable flow path of the exited refrigerant through the technical region, the gas leakage sensor is arranged closer to the blowout region than to the suction region. In particular, the gas leakage sensor is arranged at the end of the technical region in the transition to the blowout region. The sensitivity according to the invention of the gas leakage sensor and at the same time the high volume flow in the technical region enable an ideal interrelation of the detection of leaks, but also an additional failure security, since, while during a normal ventilation with the product air, already a certain environmental influence on the ambient air may trigger the sensor alarm value, at the solution according to the invention, an unusually excessively contaminated ambient air is required for triggering a false alarm.

According to a further exemplary embodiment, the water generator comprises an inclination sensor. The inclination sensor is configured for determining a horizontal orientation of the water generator, wherein in particular the control unit is configured for stopping an operation of the water generator in case of a predetermined deviation of the water generator from the horizontal orientation. When the water generator is not placed in a sufficiently horizontally oriented manner, the control unit as security unit prevents e.g. the operation of the water generator. In case of a non-horizontal placement of the water generator, there is the risk that possible condensing water (e.g. at a refrigerant conduit) collects in a corner of the technical region, where it is difficult to evaporate again. In case of a horizontal orientation, the bottom of the water generator serves as a large area evaporation zone and therefore prevents accumulated dripping water collections.

According to a further exemplary embodiment, the height at least of the suction region, of the technical region and/or of the blowout region is smaller than 2.7 m, in particular smaller than 2.4 m, or than 2 m. The width of the suction region, of the technical region and/or of the blowout region is smaller than 2.4 or 2.35 m, in particular smaller than 2 m.

Therefore, the water generator can be placed in a euro container (e.g. in a 40 feet (“high cube”) container). At the water generator, the dimensions of the entire contour are sufficiently small, such that the inner dimension of a euro container is larger at each position. The solution according to the invention contributes to this in terms of the humidity-reduced product air being guided through the entire water generator, i.e. through the entire technical region up to the suction region and is blown out commonly with the waste air which is present there. Thus, no external tube conduits etc. are necessary. Additionally, the large inner free flow cross-section in the technical region forms no high damping of the volume flow and thereby no high pressure drop, which in turn results in a smaller required driving power of the fans.

According to a further exemplary embodiment, the water generator comprises a water container which is coupled with the water collection unit such that the collected water from the water collection unit is storable in the water container, wherein the water container is in particular arranged in the technical region. The water container comprises a water storage volume of more than 300 L, in particular more than 800 L.

By the arrangement of the water container in the technical region, a double use in connection with the high flow of the cooler humidity-reduced product air results than e.g. in case of being flown around with warm ambient air. On the one hand, the water acts as an additional coldness storage for the storage according to the invention of as much coldness as possible for an interruption- and operation stability, on the other hand, the water can be stored in a cooled manner until the removal. When an auxiliary energy is present, by a removal pump, the water removal in the moments of the failure of the main supply can additionally be ensured. From water storage sizes of 300 L, efficiency- or operational robustness improvements are properly detectable.

According to a further exemplary embodiment, the water generator comprises a water pump which is coupled with the water container, such that the water can be pumped out of the water container. In particular, the water pump is operable with an auxiliary energy system, in particular with a photovoltaic-operated auxiliary energy system, further in particular with a storage for electric energy.

According to a further exemplary embodiment, the water generator comprises an auxiliary energy system which is configured for supplying at least the control unit during a short current failure with auxiliary energy, wherein the auxiliary energy system in particular comprises a photovoltaic system and/or a rechargeable storage for electric energy (current storage) which is rechargeable in particular by the photovoltaic system.

The current storage may in particular be accommodated in the technical region. This current storage (accumulator) may be used for the electrical components, such as the control unit, when bypassing current failures. Mechanical technical components, such as e.g. the ventilator or the compressor, in case of a very short current failure, by their inherent moment of inertia, may bypass the current failure, however not unconditionally the required control electronics (control unit). Furthermore, the current storage may serve as intermediate storage of solar energy or for a night-bypassing of the communication in the offline mode of the water generator. The high volume flow according to the invention of the humidity-reduced product air may flow around this current storage in the technical region, in particular with a product air temperature which is cooler than the outer air and may thus counteract both a self-warming of the current storage and high outer air temperatures, such that high current storage temperatures are not achieved at all. This positively effects, among others, the lifetime of the current storage.

According to a further exemplary embodiment, the photovoltaic system comprises solar cells which are arranged on the roof of a housing of the water generator, in particular the roof of the technical region, wherein the solar cells are thermally coupled with the roof of the housing. Thermally coupled means that a heat transfer between the solar cells and the housing of the water generator is existing and heat energy can be exchanged. These solar cells are for example connected (at least partially) with the technical region in a heat conductive manner. This enables a temperature reduction, in each case even a cooling of at least the solar cells which are close to the technical region. In case of a lower temperature, the degree of efficiency of solar cells is higher, which in turn contributes to the total efficiency of the system.

The auxiliary energy system may therefore be a rechargeable current storage or a photovoltaic system, as explained in the above sections. Alternatively, also local small energy sources, in particular small generators or fuel cells, are possible. This auxiliary energy is not sufficient for operating the large ventilators or the compressor, but they can maintain the communication during the failure period of the main energy supply, can supply the control with current, can supply the monitoring systems, can maintain the actuators of the product air control under voltage and reference position, and, when using oil-containing compressors, can operate a Carter heater which is required in each case, such that, when the main supply restarts, the water production can be rapidly started. This enables, together with maintaining the coldness in the technical region, a very rapid restart after a disturbance of the operation, namely with a high efficiency.

According to a further exemplary embodiment, the compressor is arranged in the technical region, wherein the compressor is in particular thermally coupled with the humidity-reduced product air. Therefore, the compressor may be cooled in operation.

According to a further exemplary embodiment, the suction region and the technical region respectively comprise a flow cross-section for the product air and/or the humidity-reduced product air, wherein the flow cross-section in the technical region is larger, in particular 1.2 times, further in particular 1.4 times, further in particular 1.6 times larger, than the flow cross-section in the suction region.

For example, the flow cross-section, i.e. the free space for the flow in the regions, in particular in the technical region, is over-dimensioned with respect to the required target values for the defined flow amount of product air. For example, when the waste air channel size for a water generator of 23,000 m² product air constitutes a channel (or free cross-section) of 200 cm×240 cm, this results in a product air flow velocity of about 10 m/second in case of a clear free space (German: lichter Freiraum) of 0.62 m². By enlarging the free space in the technical region to 1 m², e.g. by a suitable placement of the technical components, the flow velocity at the same volume flow can be reduced to slightly more than 6 m/second. Thereby, the flow resistances for bypassing the flow distance are significantly reduced over the technical region, which in turn increases the efficiency. According to the invention, corresponding efficiency improvements could be detected from a cross-section enlargement of 1:1.2, preferably when it is more than 1:1.4, in particular as illustrated in the above example, more than 1:1.6.

According to a further exemplary embodiment, the water generator comprises a ventilator for recirculating (German: Umwälzung) and/or for adjusting the flow of the product air. The ventilator is arranged in the suction region and/or in a transition region between the suction region and the transition region, such that the ventilator sucks the humidity-reduced product air after passing the water collection unit. This has the advantage that the waste heat of the ventilator is acting less efficiency-reducing.

According to a further exemplary embodiment, the ventilator comprises an air-cooled motor which is coolable by an outer air supply. In particular, the ventilator is arranged in the suction region. In particular, the ventilator may be arranged in the transition to the technical region. In particular in the suction region, a heat exchanger, in particular a cross heat exchanger, is arranged. The heat exchanger is suppliable with the outer air and the humidity-reduced product air, such that the outer air is cooled for the air-cooled motor and the humidity-reduced product air is heated for being forwarded into the technical region.

Thus, the product air is blown by the ventilator through the water generator. In contrast to the obvious placement of the fan as close as possible to the inlet of the ambient air in the suction region, in the embodiment according to the invention, the ventilator is placed in the product air flow only in the transition from the suction region into the technical region. Thereby, the product air is sucked through the suction region and is blown through the technical region. This has the advantage that the waste heat of the ventilator additionally heats the product air for the technical region, which correspondingly reduces the relative air humidity of the humidity-reduced product air in the technical region. This additionally reduces the formation of condensed water in the technical region. This heating also functions for ventilators with attached motor with an own air cooling, since via the motor shaft and the propeller friction of the fan, heat is nevertheless introduced into the product air. Additionally, in front of this ventilator, a cross heat exchanger may be placed, which pre-cools the sucked ambient air and in turn additionally heats the product air for the technical region.

According to a further exemplary embodiment of the method, at least the control unit is supplied with auxiliary energy from an auxiliary energy system during a short current failure.

According to a further exemplary embodiment of the method, when starting or restarting the water generator, the control unit determines, based on ambience data, sensor data, time factors and/or historical data (e.g. from a database), if, prior to starting the compressor, a flooding of the technical region with ambient air and/or product air is performed and for which time period the technical region is flown through with ambient air and/or product air.

For example, by a temperature sensor, the inner temperature in the technical region may be measured. The thereby detected temperature value is compared with other parameters (e.g. temporal (temperature) course, outer temperature, target working point, etc.) and, based on this, a flow-through-time of the water generator, in particular of the technical region, with outer air and/or product air when restarting after a current interruption is determined, such that selectively the water production is started earlier or alternatively it is being waited sufficiently long, such that the relevant technical components in the technical region are cooled, to achieve a better total lifetime.

In a further embodiment, the water generator is rinsed under certain operation conditions during the start, in particular the restart after a short current interruption, at first with still not dehumidified product air. This reduces the temperature in the technical region for cases where the coldness maintenance could delay the temperature increase not long enough. For this purpose, a control can use either the already mentioned temperature sensor/-detector as a reference. It can also be simulated and/or pre-determined, if an overheating in the technical region is present and, in this way, it may be decided situation-dependently about a flooding with outer air or (e.g. not humidity-reduced) product air prior to the start.

According to a further exemplary embodiment, the control unit determines the available power of an energy source from which the water generator draws the electric energy which is required for the operation, and controls the power of the compressor based on the available power of the energy source.

It should be noted that the here described embodiments merely constitute a limited selection of possible embodiment variants of the invention. Thus, it is possible to combine the features of single embodiments with each other in a suitable manner, such that, for the skilled person, with the here explicit embodiment variants, a multiplicity of different embodiments are to be considered as obviously disclosed. In particular, some embodiments of the invention are described with device claims and other embodiments of the invention with method claims. However, when reading this application, it is immediately clear to the skilled person that, unless explicitly otherwise indicated, additionally to a combination of features which belong to one type of inventive subject-matter, also an arbitrary combination of features is possible which belong to different types of inventive subject-matters.

### BRIEF DESCRIPTION OF THE DRAWINGS

In the following, for the further explanation and for a better understanding of the present invention, embodiments are described in more detail referring to the accompanied drawings. It is shown:

FIG. 1 shows a schematic illustration of the water generator according to an exemplary embodiment of the invention.

FIG. 2 shows a schematic illustration of a refrigerant cycle with respect to certain regions of the water generator according to an exemplary embodiment of the invention.

FIG. 3 shows a schematic illustration of a water generator, wherein the refrigerant cycle is coupled via cooling coupling cycles with the water collecting unit and/or with the re-cooling unit, according to an exemplary embodiment of the invention.

### DETAILED DESCRIPTION OF EXEMPLARY EMBODIMENTS

Same or similar components in different figures are provided with the same reference numbers. The illustrations in the figures are schematic.

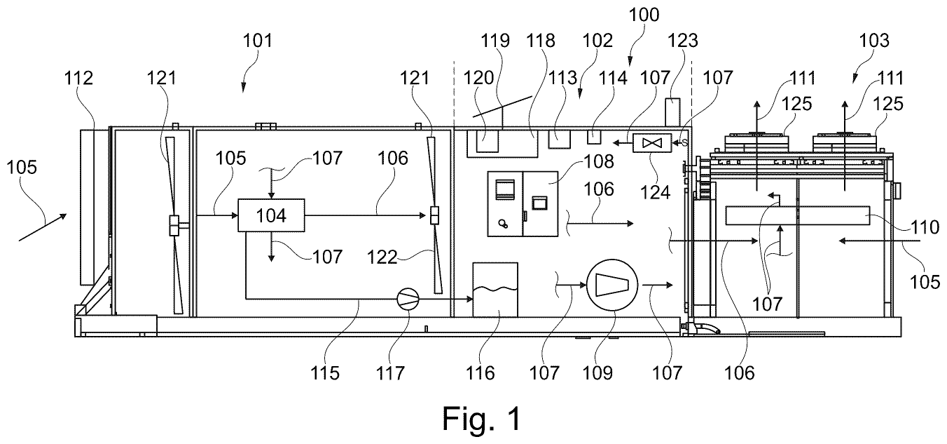

FIG. 1 shows a schematic illustration of a water generator 100 for generating water 115 from atmospheric ambient air 105 according to an exemplary embodiment of the invention. The water generator 100 in particular comprises an energy efficiency of less than 250 W/liter water yield.

The water generator 100 comprises a refrigerant cycle 200 for generating cooling power. The water generator 100 further comprises a suction region 101, in which ambient air 105 from an ambience is suckable. The suction region 101 comprises a water collection unit 104 with a cooling register. The cooling register is coupled with the refrigerant cycle 200 and is adapted such that, by the cooling power of the refrigerant cycle 200 from the ambient air 105, which is flowable as product air 106 at least partially through the cooling register, water 115 and humidity-reduced product air 106 is generatable.

Furthermore, the water generator 100 comprises a technical region 102, in which technical components comprising at least one control unit 108 for operating the water generator 100 are installable, wherein the metal portion of the technical components in the technical region 102 comprises more than 500 kg.

Furthermore, the water generator comprises a blowout region 103 for blowing out the humidity-reduced product air 106 into the environment. Additionally, the water generator 100 comprises a compressor 109 for compressing the refrigerant 107, wherein the compressor 109 comprises a maximum connecting power in the range from 70 kW to 200 kW. The blowout region 103 comprises a re-cooling unit 110 which is thermally coupled with the refrigerant cycle 200 and is adapted, under release of waste heat, to liquefy the refrigerant 107 and/or to the re-cooling intermediate cycle (cooling coupling cycle 302) and/or refrigerant cycle 200. In addition, in the blowout region 103, ambient air 105 from the ambience is flowable for cooling the liquefying unit 110.

The suction region 101, the technical region 102 and the blowout region 103 are arranged such that at least a part of the humidity-reduced product air 106 is flowable from the suction region 101 through the technical region 102 under thermally coupling with at least a part of the technical components in the blowout region 103. In the blowout region 103, the part of the humidity-reduced product air 106 is mixed with the sucked ambient air 105 and is subsequently flown through the re-cooling unit 110 for removing the waste heat.

The control unit 108 is configured for controlling the product air 106 such that the relative air humidity in the humidity-reduced product air 106 in the technical region 102 is less than 60%. Furthermore, the control unit 108 is configured for controlling the product air 106 such that the temperature of the humidity-reduced product air 106 in the technical region 102 is adjustable to be cooler than the ambient air 105.

In particular, in the flow direction of the product air 106 through the water generator 100, the suction region 101, the technical region 102 and the blowout region 103 are subsequently arranged. The main regions may form a common housing. Furthermore, the main regions may respectively comprise an own carrying structure and/or separate housings which may be coupled with each other in a modular manner.

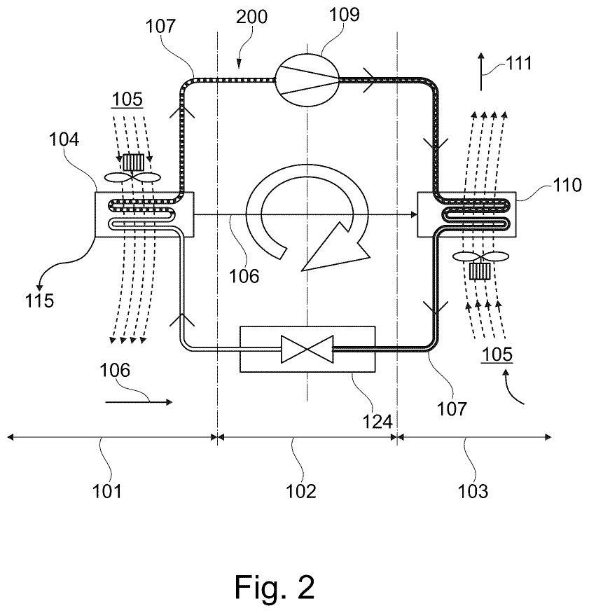

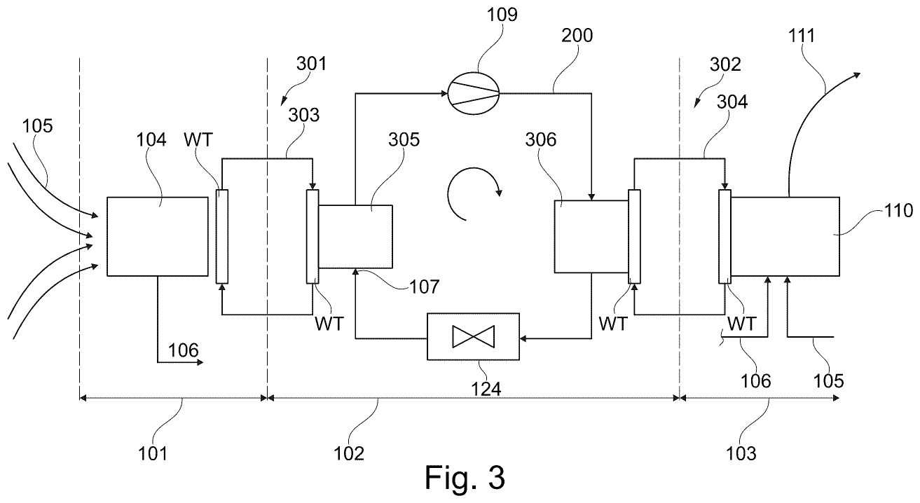

In the suction region, for example a ventilator 121 for sucking the ambient air 105 is located. The ambient air 105 is sucked into the suction region 101 as product air 106 and is in particular flown into the water collection unit 104, in which the product air 106 is cooled, in particular below the dew point. In particular, the cooling power is generated directly by a refrigerant 107 from a refrigerant cycle 200 (see FIG. 2) or indirectly via a cooling coupling cycle 301 by a thermal carrier medium 303 (see FIG. 3).

By the atmospheric water generator 100, typically warm ambient air 105 is sucked in the suction region 101 and is cooled as product air 106 directly or indirectly by a refrigerant cycle which is operated by the refrigerant 107, until below the dew point and the air humidity condenses out of the product air 106. The cooling energy which is required for this is provided by a refrigerating machine or the refrigerant cycle 200 (i.e. the compressor 109 in the refrigerant cycle 200). The heat which is removed from the air is transported back to the ambience again via a re-cooling unit 110 and a directly or indirectly thermally coupled liquefying unit for liquefying the refrigerant 107.

The product air 106 describes the ambient air 105 which flows into the water generator 100 and flows in the interior (for example in the interior of the entire housing of the water generator 100). Behind the water collection unit 104, the product air 106 is a humidity-reduced product air 106, since behind the flown-through water collection unit 104, water is condensed and the humidity content of the product air 106 is reduced. In the water collection unit, for example 80% of the water content of the product air 106 may be condensed. The humidity-reduced product air 106, after the water collection unit 104, according to the invention flows through the technical region 102 into the blowout region 103.

In the technical region 102, most of the technical components of the water generator 100 are arranged. The technical components are flown around by the humidity-reduced product air 106 and are therefore thermally coupled. Thermally coupled means that heat from the technical components is released to the cooled humidity-reduced product air 106. Due to the high metal portion, the technical components store the coldness.

In the blowout region 103, the re-cooling unit 110 is installed. The re-cooling unit 110 is cooled by flown-in ambient air 105 and by the humidity-reduced product air 106 which flows from the technical region 102 into the blowout region 103. By the additional cooling of the humidity-reduced product air 106, the efficiency of the re-cooling unit 110 and the liquefying unit of the refrigerant cycle 200 which is coupled with it is increased. After flowing around the re-cooling unit 110, the waste air which is consisting of the humidity-reduced product air 106 and the ambient air 105 which is flown in the blowout region, is blown out by a fan 125. The fan 125 is arranged on the roof of the housing of the blowout region 103, for example.

Furthermore, the blowout region 103 is spatially separated by the technical region 102 from the suction region 101. Thus, the position where the ambient air 105 for the water collection unit 104 is sucked into the suction region 101 is spatially distanced from the position where in the blowout region 103 the waste heat 111 is blown out which is heated by the re-cooling unit 110. Therefore, mixing the warm waste air 111 with the cooler ambient air 105 which is supplied in the suction region 101 is prevented and an efficiency reduction is avoided.

In particular, the power of the water generator 100 is controlled by the control of the compressor 109 for compressing the refrigerant 107. For example, when the compressor power of the compressor 107 is adapted to the optimum operation point, the refrigerant can cool the product air 106 more efficiently, and correspondingly, the amount of condensed water 115 can be controlled. Furthermore, the power of the water generator 100 can be controlled by the volume flow of the ambient air 105 which is flown-in in the suction region 101 and/or by the volume flow of the ambient air 105 which is flown-in in the blowout region 103. By the volume flow of the product air 106 in the suction region 101 and a corresponding supply into the water collection unit 104, the amount of humidity-reduced product air can be adjusted. The corresponding volume flows may be controlled by respective ventilators 121, 125 in the suction region 101 and/or in the blowout region 103, for example.

In particular, the control unit 108 is provided for operating the water generator 100 and is installed in the technical region 102. In particular, the control unit controls the compressor 109. Furthermore, the control unit 108 may control the corresponding ventilators 121, 125, for adjusting the volume flows of the product air 106 and/or of the inflowing ambient air 105 in the blowout region 103. Thus, according to the invention, the humidity-reduced product air 106 in the technical region 102 may comprise a relative air humidity of below 60%.

Furthermore, in the water generator, corresponding sensors may be arranged for measuring suitable operation parameters. For example, in the suction region 101, the technical region 102 and/or the blowout region 103, corresponding temperature sensors, air pressure sensors and/or air humidity sensors may be provided. Furthermore, corresponding outer sensors 123 outside the water generator 100 may be provided, for example for measuring the temperature, the air pressure and the relative air humidity of the ambient air 105. In particular, the control unit 108 may be coupled with the inner sensors and/or the outer sensors 123, to therefore control the compressor 109 and/or the ventilators 121, 125 based on the corresponding sensor data, and to therefore adjust an optimum operation point for the generation of water 115 in the water collection unit 104.

Thus, when starting or restarting the water generator 100, the control unit 108 determines, based on environmental data, sensor data, time factors and/or historical data (e.g. from a database), if, prior to the start of the compressor 109, a flooding of the technical region 102 with ambient air 105 and/or product air 106 is performed, and for which time period the technical region 102 is flown-through with ambient air 105 and/or product air 106. For example, by a temperature sensor, the inner temperature in the technical region 102 may be measured. The thereby detected temperature value is compared with other parameters (e.g. (temperature-) course over time, outer temperature, target operation point, etc.) and based on this, a rinsing time of the water generator 100, in particular of the technical region 102, with ambient air 105 (i.e. with outer air) and/or product air 106 when restarting after a current interruption is determined, such that selectively the water production is started earlier, or alternatively it is waited long enough, such that the relevant technical components in the technical region 102 are cooled, to achieve a better total lifetime.

The control unit 108 further determines the available power of an energy source from which the water generator 100 draws the electric energy which is required for the operation, and controls, based on the available power of the energy source, the power of the compressor 109 and/or of the ventilators 121 or fans 121.

By the length of the technical region 102, the outlet of the waste air 111 in the blowout region 103 is additionally further distanced from the suction of the ambient air 105 in the suction region 101 by the length of the technical region 102, whereby the risk of sucking heated, blown-out waste air 111 is reduced.

By the control unit 108, a constant volume flow by controlling the ventilators 121 or fans 125 is adjusted. According to the invention, the volume flow through the technical region 102 may be adjustable in particular between 10,000 m³/h and 30,000 m³/h.

The humidity-reduced product air 106 in the technical region 102 is adjusted such that the humidity-reduced product air 106 is adjusted to be between 2° C. and 10° C. cooler than the ambient air. Furthermore, the control unit 108 controls the volume flow of the product air 106 and the cooling power of the refrigerant 108, such that a temperature increase of the product air 106 during flowing through the technical region is less than 3° C.

Furthermore, the water generator 100 comprises a filter unit 112 for filtering the product air 106, wherein the filter unit 112 is configured such that more than 60% of all particles with a size from 0.3 μm to 1 μm are filterable out of the humidity-reduced product air 106 which flows through the technical region 102. In particular, the filter unit 112 is arranged at the inlet region of the suction region 101, such that the filter unit 112 filters the ambient air 105 which is flowing into the suction region. For example, a further filter unit may be provided at the air inlet of the ambient air 105 in the blowout region 103.

In particular, the inlet region of the suction region 101 and the inlet region of the blowout region 103 for the ambient air 105 may be arranged at opposite front sides of the water generator 100. In an exemplary embodiment, an inlet region of the blowout region 103 for the ambient air 105 may also be provided at side faces of the blowout region 103. The waste air 111 is then blown out upwardly via the roof of the blowout region 103, for example.

The water generator 100 further comprises a gas leakage sensor 113 for determining a portion of the refrigerant 107 in the product air 106, wherein the gas leakage sensor is arranged in the technical region 102. The gas leakage sensor 113 comprises for a determination of the refrigerant a sensitivity of more than 20 ppm (parts per million) of the refrigerant 107 in the product air 106. In particular, the gas leakage sensor 113 is arranged at the bottom of the water generator 100, to be able to better determine occurring concentrations of a leaked refrigerant 107. The gas leakage sensor 113 is mounted such that it is arranged subsequently to possible leaks in the flow. With respect to a probable flow path of the leaked refrigerant 107 through the technical region 102, the gas leakage sensor 113 is arranged closer to the blowout region 103 than to the suction region 101. In particular, the gas leakage sensor 113 is arranged at the end of the technical region 102 in the transition to the blowout region 103.

The water generator 100 further comprises an inclination sensor 114. The inclination sensor 114 is configured for determining a horizontal orientation of the water generator 100, wherein in particular the control unit 108 is configured, in case of a predetermined deviation of the water generator 100 from the horizontal orientation, to stop an operation of the water generator 100.

The water generator 100 comprises a water container 116 which is coupled with the water collection unit 104, such that the collected water 115 from the water collection unit 104b is storable in the water container 116. The water container 116 is arranged in the technical region 102. The water generator 100 comprises a water pump 117 which is coupled with the water container 116, such that the water 115 can be pumped out of the water tank 116. In particular, the water pump 117 is operable with an auxiliary energy system 118, in particular comprising a photovoltaic system 119 and/or an electronic storage 120. For example, the water pump 117 is arranged for emptying the water container 116 at a corresponding outlet behind the water container 116.

The auxiliary energy system 118 is configured for supplying at least the control unit 108 during a short current failure with auxiliary energy. In particular, the electronic storage (current storage) 120 may be charged by the photovoltaic system 119. In particular, the current storage 120 may be accommodated in the technical region 102. This current storage (accumulator) 120, in the case of bypassing current failures, may be used for the electronic components, such as the control unit 108.

The photovoltaic system 119 comprises solar cells which are arranged on the roof of a housing of the water generator 100, in particular the roof of the technical region 102, wherein the solar cells are thermally coupled with the roof of the housing, to provide a heat conduction between the solar cells and the housing of the water generator 100, and heat energy can be exchanged. This enables a temperature reduction of at least the solar cells which are arranged close to the technical region 102. In case of a lower temperature, the degree of efficiency of solar cells is higher, which in turn contributes to the total efficiency of the system.

The compressor 109 is arranged in the technical region 102, wherein the compressor 109 in particular is thermally coupled with the humidity-reduced product air 106. Thus, the compressor 109 may be cooled in operation.

The suction region 101 and the technical region 102 each comprise a flow cross-section for the product air 106, wherein the flow cross-section in the technical region 102 is larger, in particular at least 1.2 times larger, than the flow cross-section in the suction region 101.

The ventilator 121 is arranged in the suction region 101 in the transition to the technical region 102 and comprises an air-cooled motor 122, for example, which is coolable by an outer air supply. For example in the suction region 101, a heat exchanger, in particular a cross heat exchanger, is arranged, wherein the heat exchanger is suppliable with the ambient air 105 and the humidity-reduced product air 106, such that the technical region 102 is cooled for the air-cooled motor 122 and the humidity-reduced product air 106 is heated for being forwarded into the technical region 102.

FIG. 2 shows a schematic illustration of a refrigerant cycle 200 referring to the suction region 101, the technical region 102 and the blowout region 103 of the water generator according to an exemplary embodiment of the invention.

The atmospheric water generator 100 draws the cooling power from a refrigerant cycle 200 which functions according to the principle of a heat pump. The refrigerant 107 is compressed, the resulting compression- or condensation heat is removed and the refrigerant 107 which is compressed or liquefied in this manner is relaxed or evaporated via an expansion valve 124. The coldness which is provided in this manner is used for cooling humid product air 106 in the cooling register of the water collection unit 104 which then condenses and therefore the water 115 is obtained.

In particular, the refrigerant cycle 200 comprises a directly coupled and/or integrated evaporating unit in the suction unit 101, in which evaporating unit the refrigerant 107 is evaporated and therefore cooled. The evaporated refrigerant 107 is further forwarded to the compressor 109 in the technical region 102 which increases the pressure of the refrigerant 107 and forwards to the liquefying unit. The liquefying unit is thermally coupled to the re-cooling unit 110. The re-cooling unit 110 is arranged in the blowout region 103 and is cooled by ambient air 105 and the humidity-reduced product air 106, to directly or indirectly cool the refrigerant 107 by a further cooling coupling cycle 302, until a liquid state of the refrigerant 107 is achieved. Subsequently, the refrigerant 107 is forwarded to an expansion valve 124 for reducing the pressure, and subsequently back to the evaporating unit. The evaporating unit is directly thermally coupled with the water collection unit 104 or is indirectly coupled with the water collection unit 104 by a further cooling coupling cycle 302 (see FIG. 3).

The water collection unit 104 comprises in the suction region 101 a cooling register and a first heat exchanger which is supplied on the one hand with the cooler refrigerant 107 from the liquefying unit and on the other hand by the heated sucked product air 106, such that the product air 106 is cooled. In the cooling register comprising e.g. a condenser or drop separator, the relative air humidity of the humidity-reduced product air 106 is reduced, for example below 40%. The such strongly cooled humidity-reduced product air 106 is subsequently supplied into a second heat exchanger. The sucked product air 106, after entering into the suction region 101, prior to flowing through the water collection unit 104, also flows directly into the second heat exchanger. Thus, the humidity-reduced product air 106 from the water collection unit 104 pre-cools the sucked product air 106 and is itself heated again. The therefore already pre-cooled sucked product air 106 is supplied via a second drop separator to the first heat exchanger. The heated humidity-reduced product air 106, when flowing into the technical region 102, then comprises a lower temperature compared to the ambient air 105 and can be used for a moderate cooling of the technical components in the technical region 102, without a risk of condensing at the technical components.

According to the invention, for the product air 106, when flowing into the technical region 102, a temperature reduction of 2° C. to 7° C. below the outer temperature level of the ambient air 105 may be adjusted.

FIG. 3 shows a schematic illustration of a water generator 100, wherein the refrigerant cycle 200 is coupled via cooling coupling cycles 301, 302 with the water collection unit 104 and/or with the re-cooling unit 110.

The refrigerant cycle 200 comprises an evaporating unit 305 for evaporating the refrigerant 107. The evaporating unit 305 is arranged in the technical region 102 and is thermally coupled with the cooling register of the water collection unit 104 via a first cooling coupling cycle 301. The first cooling coupling cycle 301 is thermally coupled with the evaporating unit 305 and the cooling register, such that a thermal carrier medium 303 of the first cooling coupling cycle 301 transfers the cooling power of the refrigerant 107 onto the cooling register. Thus, the evaporating unit 305 is arranged separately from the cooling register in the technical region 102.

Therefore, a transition of cooling power occurs between the refrigerant 107 of the evaporating unit 305 and the thermal carrier medium 303 via a heat exchanger WT (307) which is arranged in the technical region 107. A further transition of cooling power between the refrigerant 107 and the warmer product air 106 occurs in the suction region 101 via a further heat exchanger WT which is coupled to the water collection unit 104.

Furthermore, the refrigerant cycle 200 comprises a liquefying unit 306 in the technical region 102 for liquefying the refrigerant 107. A second cooling coupling cycle 302 is thermally coupled with the liquefying unit 306 and the re-cooling unit 110, such that a second thermal carrier medium 304 of the second cooling coupling cycle 302 transfers a cooling power of the second thermal carrier medium 304 onto the liquefying unit 306, to cool the refrigerant 107. Thus, the liquefying unit 306 is arranged separately from the re-cooling unit 110.

Thus, a transition of heat between the refrigerant 107 of the liquefying unit 306 and the thermal carrier medium 304 occurs via a heat exchanger WT which is arranged in the technical region 107. A further transition of heat between the refrigerant 107 and the humidity-reduced product air 106 and the ambient air 105 occurs in the suction region 101 via a further heat exchanger WT which is coupled to the re-cooling unit. Therefore, in the exemplary embodiment of FIG. 3, all components of the refrigerant cycle 200 may be arranged in the technical region 102.

Supplementary, it is to be noted that “encompassing” does not exclude other elements or steps and “a” or “an” does not exclude a multiplicity. Furthermore, it is noted that features or steps which are described with reference to one of the above embodiments may also be used in combination with other features or steps of other above-described embodiments. Reference signs in the claims are not to be construed as limitation.

### LIST OF REFERENCE SIGNS

100 water generator
101 suction region
102 technical region
103 blowout region
104 water collection unit
105 ambient air
106 product air medium
107 refrigerant
108 control unit
109 compressor WT heat exchanger
110 re-cooling unit
111 waste air
112 filter unit
113 gas leakage sensor
114 inclination sensor
115 water
116 water container
117 water pump
118 auxiliary energy system
119 photovoltaic system
120 electrical storage
121 ventilator
122 motor
123 outer sensor
124 expansion valve
125 fan
200 refrigerant cycle
301 first cooling coupling cycle
302 second cooling coupling cycle
303 first thermal carrier medium
304 second thermal carrier
305 evaporating unit
306 liquefying unit

1-32. (canceled)

33. A water generator for generating water from atmospheric ambient air, the water generator comprising:
a refrigerant cycle for generating cooling power;
a suction region in which ambient air from an ambience is suckable,
wherein the suction region comprises a water collection unit with a cooling register,
wherein the cooling register is coupled with the refrigerant cycle and adapted such that, by the cooling power of the refrigerant cycle, from the ambient air which is flowable as product air at least partially through the cooling register, water and humidity-reduced product air is generatable;
a technical region in which technical components comprising at least one control unit for operating the water generator are installed,
wherein the metal portion of the technical components in the technical region comprises more than 500 kg;
a blowout region for blowing out the humidity-reduced product air into the ambience; and
a compressor for compressing the refrigerant, wherein the compressor comprises a maximum connection power in the range from 70 KW to 200 KW,
wherein the blowout region comprises a re-cooling unit which is thermally coupled with the refrigerant cycle and which is adapted to liquefy the refrigerant under the release of waste heat,
wherein ambient air from the ambience is flowable in the blowout region,
wherein the suction region, the technical region and the blowout region are arranged such that at least a part of the humidity-reduced product air is flowable from the suction region through the technical region under thermally coupling with at least a part of the technical components into the blowout region,
wherein in the blowout region the part of the humidity-reduced product air is mixable with the sucked ambient air, and subsequently is flowable through the re-cooling unit for the removal of the waste heat,
wherein the control unit is configured to control the product air such that the relative air humidity in the product air in the technical region is less than 60%, and
wherein the control unit is further configured to control the product air such that the temperature of the product air in the technical region is adjustable to be cooler than the ambient air.

34. The water generator according to claim 33,
wherein the refrigerant cycle comprises an evaporating unit for evaporating the refrigerant.

35. The water generator according to claim 34,
wherein the evaporating unit is arranged in the suction region and is thermally coupled with the cooling register, to transfer the cooling power of the refrigerant to the cooling register.

36. The water generator according to claim 34, further comprising
a first cooling coupling cycle which is thermally coupled with the evaporating unit and the cooling register, such that a thermal carrier medium of the first cooling coupling cycle transfers the cooling power of the refrigerant to the cooling register,
wherein the evaporating unit is arranged separated from the cooling register.

37. The water generator according to claim 33,
wherein the refrigerant cycle comprises a liquefying unit for liquefying the refrigerant.

38. The water generator according to claim 37,
wherein the liquefying unit is arranged in the blowout region and is thermally coupled with the re-cooling unit for cooling the refrigerant.

39. The water generator according to claim 37, further comprising
a second cooling coupling cycle which is thermally coupled with the liquefying unit and the re-cooling unit, such that a second thermal carrier medium of the second cooling coupling cycle transfers a cooling power of the second thermal carrier medium to the liquefying unit for cooling the refrigerant,
wherein the liquefying unit is arranged separated from the re-cooling unit.

40. The water generator according to claim 33, comprising at least one of the following features:
wherein the energy efficiency under predetermined conditions is less than 250 W/liter water yield;
wherein the length of the technical region is more than 1 m.

41. The water generator according to claim 33, comprising at least one of the following features:
wherein the control unit is configured to control the product air, such that the product air in the technical region comprises a relative air humidity of less than 50%;
wherein the volume flow of the product air is constant,
wherein the volume flow is adjustable between 10,000 m³/h and 30,000 m³/h;
wherein the product air in the technical region is adjustable such that the product air is more than 2° C. cooler than the ambient air;
wherein the product air in the technical region is adjustable such that the product air is less than 10° C. cooler than the ambient air;
wherein an air exchange per hour in the technical region with respect to the inner volume of the technical region is more than 200 times of the inner volume of the technical region.

42. The water generator according to claim 33, comprising at least one of the following features:
wherein the metal portion in the technical region is more than 1000 kg;
further comprising
a filter unit for filtering the product air,
wherein the filter unit is configured such that more than 60% of all particles with a size from 0.3 μm to 1 μm can be filtered out of the product air which is flowing through the technical region;
further comprising
a gas leakage sensor for determining a portion of the refrigerant in the product air,
wherein the gas leakage sensor is arranged in the technical region,
wherein the gas leakage sensor for determining the refrigerant comprises a sensitivity of more than 20 ppm of the refrigerant in the product air;
further comprising
an inclination sensor,
wherein the inclination sensor is configured for determining a horizontal orientation of the water generator,
wherein the control unit is configured, in case of a predetermined deviation of the water generator from the horizontal orientation, to stop an operation of the water generator;
wherein the height at least of the suction region, of the technical region or of the blowout region is less than 2.7 m, and/
wherein the width at least of the suction region, of the technical region or of the blowout region is less than 2.35 m.

43. The water generator according to claim 33, further comprising
a water container which is coupled with the water collection unit such that the collected water from the water collection unit is storable in the water container,
wherein the water container is arranged in the technical region,
wherein the water container comprises a water storage volume of more than 300 liter.

44. The water generator according to claim 43, further comprising
a water pump which is coupled with the water container such that the water can be pumped out of the water container,
wherein the water pump is operable with an auxiliary energy system, with a photovoltaics-operated auxiliary energy system, with a storage for electric energy.

45. The water generator according to claim 33, further comprising
an auxiliary energy system which is configured to supply at least the control unit during a short power failure with auxiliary energy,
wherein the auxiliary energy system comprises a photovoltaic system or a rechargeable storage for electric energy which is rechargeable by the photovoltaic system.

46. The water generator according to claim 45,
wherein the photovoltaic system comprises solar cells which are arranged on a roof of a housing of the water generator,
wherein the solar cells are thermally coupled with the roof of the housing.

47. The water generator according to claim 33, comprising at least one of the following features:
wherein the compressor is arranged in the technical region,
wherein the compressor is thermally coupled with the humidity-reduced product air;
wherein the suction region and the technical region respectively comprise a flow cross-section for the product air,
wherein the flow cross-section in the technical region is larger than the flow cross-section in the suction region;
wherein the control unit is configured to control the product air, such that a temperature increase of the product air while flowing through the technical region is less than 3° C.

48. The water generator according to claim 33, further comprising
a ventilator for recirculating the product air,
wherein the ventilator is arranged in the suction region or in a transition region between the suction region and the transition region, such that the ventilator sucks the product air after passing the water collection unit.

49. The water generator according to claim 48,
wherein the ventilator comprises an air-cooled motor which is coolable by an outer air supply,
wherein the ventilator is arranged in the suction region,
wherein a heat exchanger is arranged,
wherein the heat exchanger is feedable by the outer air and the humidity-reduced product air, such that the outer air is cooled for the air-cooled motor, and the humidity-reduced product air is heated for a further transmission in the technical region.

50. A method for operating an atmospheric water generator for generating water from atmospheric ambient air, wherein the water generator comprises an energy efficiency of less than 250 W/liter water yield, wherein the method comprises
generating cooling power by a refrigerant cycle,
sucking ambient air from an ambience in a suction region of the water generator,
generating, by the cooling power of the refrigerant cycle, from the ambient air which is flowable as product air at least partially through a cooling register of a water collection unit in the suction region, water and humidity-reduced product air,
wherein at least one control unit for operating the water generator is installed in a technical region in which technical components are arranged,
wherein the metal portion of the technical components in the technical region comprises more than 500 kg,
blowing the humidity-reduced product air out of a blowout region of the water generator to the ambience,
compressing the refrigerant in a compressor of the water generator,
wherein the compressor comprises a maximum connection power in a range from 70 kW to 200 KW,
wherein the blowout region comprises a re-cooling unit which is thermally coupled with the refrigerator cycle and adapted to liquefy the refrigerant under a release of waste heat,
wherein ambient air from the ambience flows into the blowout region,
wherein the suction region, the technical region and the blowout region are arranged such that at least a part of the humidity-reduced product air flows from the suction region through the technical region under thermally coupling with the technical components in the blowout region, and
mixing the part of the humidity-reduced product air with the sucked ambient air in the blowout region and subsequently flowing the mixed product air with the ambient air through the re-cooling unit for removing the waste heat,
wherein the control unit is configured to control the product air, such that the relative air humidity in the product air in the technical region is less than 60%,
wherein the control unit is further configured to control the product air, such that the temperature of the product air in the technical region is adjusted to be cooler than the ambient air.

51. The method according to claim 50,
wherein at least the control unit during a short power failure is supplied with auxiliary energy from an auxiliary energy system.

52. The method according to claim 50, comprising at least one of the following features:
wherein the control unit, when starting or restarting the water generator, based on ambience data, sensor data, time factors or historical data, determines if, prior to the start of the compressor, a flooding of the technical region with ambient air or product air is performed and for which time period the technical region is flown through;
wherein the control unit determines the available power of an energy source from which the water generator draws the electric energy which is required for the operation, and controls the power of the compressor based on the available power of the energy source.
